(19) United States
(12) Patent Application Publication
(10) Pub. No.: US 2024/0337628 A1
(43) Pub. Date: Oct. 10, 2024

(54) QUANTITATION OF UNSTABLE REACTION PRODUCT OR BREAKDOWN PRODUCT WITHOUT USAGE OF STANDARD CHEMICAL

(71) Applicant: ECI TECHNOLOGY, INC., Totowa, NJ (US)

(72) Inventors: Jake Zhu, Fair Lawn, NJ (US); Eugene Shalyt, Washington Township, NJ (US); Mike Macewan, Tuxedo Park, NY (US)

(73) Assignee: ECI TECHNOLOGY, INC., Totowa, NJ (US)

(21) Appl. No.: 18/297,235

(22) Filed: Apr. 7, 2023

(51) Int. Cl. G01N 30/02; C25D 3/38; C25D 21/12; G01N 30/74

(52) U.S. Cl. CPC G01N 30/02; C25D 3/38; C25D 21/12; G01N 30/74; G01N 2030/027

(57) ABSTRACT

The present subject matter relates to techniques for quantitation of an unstable or breakdown product generated from a raw material, e.g., bis (3-sulfopropyl)-disulfide (SPS) in acid copper plating baths. The disclosed techniques include spiking oxidant into the copper bath solution and analyzing HPLC response to quantify the absolute value of the unstable or breakdown with accuracy and precision.

### BACKGROUND

The disclosed subject matter relates to analytical chemical measurement, and more specifically, to quantitation of an unstable or breakdown product without usage of standard chemical.

Generally, unstable/breakdown products are formed during some reactions and are unstable under the reaction conditions. These products can further react or decompose, leading to the formation of other products or the consumption of reactants. Proper identification and quantitation of unstable or breakdown products are essential for understanding the reaction mechanism, optimizing the reaction conditions, and ensuring the quality and stability of the final product.

Bis-(3-sulfopropyl) disulfide (SPS), is an additive used in copper plating baths, to improve the plating performance of the bath by acting as an accelerator used in acidic copper plating electrolytes. However, SPS can decompose into breakdown products during electroplating process. The breakdown products can be the cause of wafer issues or failure, so it can be important to implement frequent monitoring and quantitation for the additive and its breakdown product. Breakdown products of SPS in acid copper plating baths include Mono-ox-SPS, formed by oxidation of SPS. Currently, cyclic voltammetric stripping (CVS) has been a widely used method for analysis of organic additives in copper plating. Certain high-performance liquid chromatography (HPLC) techniques can provide a more reliable quantitative analysis method for SPS and its breakdown products because HPLC can achieve certain separation of SPS breakdown products.

However, certain issues can arise in the use of Mono-ox-SPS, including commercial availability, determining absolute values thereof, and the practicality of synthesis for routine analysis. Retention time of Mono-ox-SPS peak in HPLC is shifting as the HPLC column ages. Additionally, more peaks eluting close by Mono-ox-SPS will be observed as the bath samples being heavily used for wafer plating. Both cases will make it difficult to identify the unstable or breakdown products, e.g., Mono-ox-SPS peak.

Therefore, there is a need to develop a method for absolute value quantitation of Mono-ox-SPS, a breakdown product from the accelerator bis (3-sulfopropyl)-disulfide (SPS) in acid copper (Cu) plating baths without the use of Mono-ox-SPS chemical.

### SUMMARY

The disclosed subject matter provides improved techniques for identification and reliable absolute value quantitation of unstable/breakdown products generated from raw materials. In some embodiments, the unstable/breakdown product includes Mono-ox-SPS, generated from the raw material, e.g., bis (3-sulfopropyl)-disulfide (SPS), in acid copper plating baths without the use of standard chemical thereof.

In some embodiments, the disclosed matter provides a method to generate a known breakdown product (Mono-xo-SPS) by spiking a predetermined amount of oxidant into a copper plating bath, which can be used as a peak identification standard for sample analysis.

In some embodiments, the disclosed subject matter provides quantitation of unstable reaction product or breakdown product without the usage of standard chemical. In certain embodiments, the quantitation includes the following steps: generating an unstable or breakdown product from a raw material to an in situ chemical reaction; calculating a concentration increase of the unstable or breakdown product based on the stoichiometric relation between the quantity of the unstable or breakdown product and the decrease of the raw material; correlating an increased detector signal to the concentration increase of the unstable or breakdown products; and establishing a calibration curve based on the correlation.

In some embodiments, the in situ chemical reaction is selected from a reduction, oxidation, or a combination thereof. In some embodiments, the increased detector signal is detected from a High-Performance Liquid Chromatography (HPLC) detector.

In some embodiments, the disclosed matter provides methods for quantifying a breakdown product of bis (3-sulfopropyl)-disulfide (SPS), in an acid copper plating bath. An example method includes spiking a predetermined amount of oxidant into a copper bath solution including SPS; generating a breakdown product by oxidizing SPS; analyzing SPS values by High-Performance Liquid Chromatography (HPLC) in the acid copper plating bath; and calculating the quantitation of the breakdown product based on the HPLC values.

In certain embodiments, the oxidant is selected from H₂O₂, S₂O₈²⁻, O₃, MnO₄⁻, Cr₂O₇²⁻, Fe (III), Ce (IV), and the combination thereof.

In certain embodiments, the concentration of oxidant is from 0.1 to 100 ppm.

In certain embodiments, the concentration of SPS in the copper plating solution is from 1 to 1000 ppm.

In certain embodiments, the molar ratio between the oxidant and SPS is from 0.001 to 1000.

In certain embodiments, the concentration of Mono-ox-SPS is from 0.1 to 100 ppm.

In certain embodiments, the oxidant is H₂O₂.

In certain embodiments, the molar ratio of H₂O₂:SPS is from 0.1 to 2.

In certain embodiments, analyzing HPLC values includes analyzing HPLC peak response.

In certain embodiments, the method further includes a calculation of the amount of increasing Mono-ox-SPS and decreasing SPS.

In certain embodiments, the method further includes a linearity calibration curve based on the calculation.

The disclosed matter also provides systems for quantifying breakdown products in an acid copper plating bath. An example system includes a spiking apparatus for adding a predetermined amount of oxidant to a copper plating bath including an analyte; an HPLC system for analyzing the amounts of analyte and breakdown products thereof in the bath; and a processing unit for calibrating the HPLC response of analyte and breakdown thereof and calculating the quantitation of breakdown products thereof.

In certain embodiments, the breakdown products include Mono-ox-SPS.

In certain embodiments, the HPLC system includes an HPLC-UV detector.

### BRIEF DESCRIPTION OF THE DRAWINGS

Reference will now be made in detail to the various exemplary embodiments of the disclosed subject matter, which are illustrated in the accompanying drawings. The accompanying drawings, where like reference numerals refer to identical or functionally similar elements throughout the separate views, serve to further illustrate various embodiments and to explain various principles and advantages all in accordance with the disclosed subject matter.

FIG. 1 provides a functional diagram of an exemplary system for quantifying breakdown products in an acid copper plating bath in an embodiment of the disclosed subject matter.

FIG. 2A illustrates H₂O₂ spike effect on SPS and Mono-ox-SPS in Cu plating bath by HPLC in an embodiment of the disclosed subject matter. FIG. 2B illustrates an HPLC chromatograph with excess amount of spiked H₂O₂ in Cu plating bath including SPS in an embodiment of the present subject matter. FIG. 2C illustrates HPLC chromatograms with appropriate amount of spiked H₂O₂ in Cu plating bath including SPS in an embodiment of the disclosed subject matter and an aged Cu plating bath sample in a production fab.

FIG. 3A and FIG. 3B provide HPLC chromatograms for different levels of spiked H₂O₂ and different incubation time in Cu plating bath in an embodiment of the disclosed subject matter.

FIG. 4 provides a calibration curve of increasing Mono-ox-SPS amount and increasing HPLC response of Mono-ox-SPS in an embodiment of the disclosed subject matter.

It is to be understood that both the foregoing general description and the following detailed description are exemplary and are intended to provide further explanation of the disclosed subject matter.

### DETAILED DESCRIPTION

The subject matter provides techniques for quantitation of Mono-ox-SPS, a breakdown product from the bis (3-sulfopropyl)-disulfide (SPS) in acid copper plating baths, via spiking H₂O₂ into the baths and calculating content values of Mono-ox-SPS.

For clarity, but not by way of limitation, the detailed description of the disclosed subject matter is divided into the following subsections:

### I. Definitions

### II. Methods of Quantitation

### I. Definitions

The terms used in this specification generally have their ordinary meanings in the art, within the context of this disclosure and in the specific context where each term is used. Certain terms are discussed below, or elsewhere in the specification, to provide additional guidance to the practitioner in describing the compositions and methods of the subject matter and how to make and use them.

For purposes of interpreting this specification, the following definitions will apply and whenever appropriate, terms used in the singular will also include the plural and vice versa.

As used herein, the term “about” or “approximately” means within an acceptable error range for the particular value as determined by one of ordinary skill in the art, which will depend in part on how the value is measured or determined, i.e., the limitations of the measurement system. For example, “about” can mean within 3 or more than 3 standard deviations, per the practice in the art. Alternatively, “about” can mean a range of up to 20%, up to 10%, up to 5%, and up to 1% of a given value. Alternatively, e.g., with respect to biological systems or processes, the term can mean within an order of magnitude, within 5-fold, and within 2-fold, of a value.

As used herein, the term “high level” when used in context of a concentration of a metal ion in a solution refers to a concentration in the range of grams per liter (g/L).

As used herein, the term “low level” when used in context of a concentration of a metal ion in a solution refers to a concentration in the range of parts per million (ppm).

Ranges provided herein are understood to be shorthand for all of the values within the range. For example, a range of 1 to 50 is understood to include any number, combination of numbers, or sub-range from the group consisting of 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 as well as all intervening decimal values between the aforementioned integers such as, for example, 1.1, 1.2, 1.3, 1.4, 1.5, 1.6, 1.7, 1.8, and 1.9. Ranges disclosed herein, for example, “between about X and about Y” are, unless specified otherwise, inclusive of range limits about X and about Y as well as X and Y. With respect to sub-ranges, “nested sub-ranges” that extend from either endpoint of the range are specifically contemplated. For example, a nested sub-range of an exemplary range of 1 to 50 can include 1 to 10, 1 to 20, 1 to 30, and 1 to 40 in one direction, or 50 to 40, 50 to 30, 50 to 20, and 50 to 10 in the other direction.

As used herein, the term “predetermined concentration/volume” as used herein refers to a known, target, standard or optimum concentration/volume of a component in a solution.

As used herein, the term “selective” or “selectively” refers to, for example, the particular monitoring, measurement, or determination of a characteristic of a specific or particular component. For example, the selective measurement of an ion refers to the measurement of one particular or predetermined target ion from a plurality of the ions present in solution.

As used herein, the term “accelerator” refers to a type of additive, e.g., in copper plating, that is used to increase the rate of copper deposition on the substrate being plated. Accelerators can work by increasing the rate of the electrochemical reaction that drives the deposition of copper ions onto the surface of the substrate.

As used herein, the term “fresh” is used to describe a sample that has not been exposed to any external conditions or treatments that could alter its chemical or physical properties. Fresh samples can be used as reference or control samples, as they can provide a baseline against which other samples can be compared. On the other hand, the term “age” can be used to describe a sample that has been exposed to some form of external treatment or condition that could alter its properties. In most cases, it refers to Cu plating bath that has been used for depositing Cu metal onto wafers. Aged samples can exhibit changes in their chemical or physical properties, which can affect the results obtained in measurement spectrometry.

As used herein, the term “spike” refers to the addition of a known amount of a compound to a sample, e.g., for the purpose of calibration or quantification in measurement spectrometry, for improving accuracy and precision of quantification.

As used herein, the term “HPLC” stands for High-Performance Liquid Chromatography, referring to a technique used to separate, identify, and quantify components in a mixture of compounds. The separated components are then detected as they exit the column, typically by a UV or other types of detectors such as a refractive index detector or mass spectrometer. The resulting data can then be analyzed to identify and quantify the individual components in the mixture. HPLC-UV refers to the combination of High-Performance Liquid Chromatography (HPLC) with Ultraviolet (UV) detection. It is a commonly used analytical technique for the separation and quantification of components in a mixture. In HPLC-UV, a mixture of compounds is separated using a column containing a stationary phase, as described in the general process of HPLC. As the components elute from the column, they pass through a UV detector, which measures the absorbance of the sample at a specific wavelength. The wavelength of the UV radiation used for detection can be selected based on the specific compounds being analyzed.

### II. Methods for Quantitation

The disclosed subject matter presents techniques for the quantitation of a breakdown product of bis (3-sulfopropyl)-disulfide (SPS) in acid copper plating baths. In certain aspects, techniques of the subject matter provide a high-performance liquid chromatography (HPLC) method with UV detector which is capable to separate, assign and report chromatographic peaks of Mono-ox-SPS and SPS. By spiking a certain amount of oxidant into freshly prepared target copper bath solution, various amounts of Mono-ox-SPS can be generated by oxidation of SPS. The increased HPLC response of Mono-ox-SPS and decreased response of SPS have a linear correlation within certain ranges. SPS is commercially available with high purity, with the assumption that 1 mole of SPS will be oxidized into 1 mole of Mono-ox-SPS, the absolute value of Mono-ox-SPS can be calculated based on the decreasing SPS content value.

Although a chromatography method has been applied to the quantitation of Mono-ox-SPS, there are challenges to retaining the results' accuracy and precision, and a peak can be misassigned. In addition, without a known concentration of analyte standard solution, HPLC detector response or values (Y-axis) and calibration curve thereof (e.g., linearity of decreasing and increasing amount for analyte and breakdown product), cannot be established and/or used accurately for quantitation in unknown samples.

Furthermore, because of a wide variant of oxidation products of SPS, the final breakdown product for SPS can depend on the reaction parameters, e.g., oxidant concentration and time. If there is excessive oxidant for SPS in copper plating baths, the produced Mono-ox-SPS can be continually oxidated into Di-ox-SPS, which can cause error data points of HPLC response value, consequently yielding inaccurate results for quantitation.

The disclosed subject matter provides a generation and absolute value quantitation of Mono-ox-SPS by spiking a certain amount of oxidant. Notably, in such quantitation, an HPLC-UV method can separate, identify, and quantify Mono-ox-SPS.

Such methods are practical for routine analysis of Mono-ox-SPS, in which absolute values can be reported across different copper plating tools without relying on the chemical vendor's additives.

Rather than a quantitation of SPS and Mono-ox-SPS, the embodiments of the disclosed subject matter can expand the coverage to the quantitation of other unstable reaction products.

An unstable reaction product can be generated in situ from the raw material, e.g., by reduction, oxidation, or other processes.

The disclosed subject matter provides quantitation of unstable reaction products or breakdown products without the usage of standard chemicals. In certain embodiments, the quantitation includes the following steps: generating an unstable or breakdown product from raw material to an in situ chemical reaction; calculating a concentration increase of the unstable or breakdown product based on the stoichiometric relation between the quantity of the unstable or breakdown product and the decrease of raw material; correlating an increased detector signal to the concentration increase of the unstable or breakdown product; and establishing a calibration curve based on the correlation.

In certain embodiments, the in situ chemical reaction is selected from a reduction, oxidation, or a combination thereof.

In certain embodiments, the increased detector signal is detected by a High-Performance Liquid Chromatography (HPLC) detector.

The calibration curve for the reaction product is built based on correlating (the detector signal/response increase of unstable reaction product) to (the concentration increase of the unstable reaction product), assuming stoichiometric relation between the quantity of reaction product and loss of raw material.

### EXAMPLES

The presently disclosed subject matter will be better understood by reference to the following examples. The following examples are merely illustrative and should not be considered as limiting the scope of the subject matter in any way.

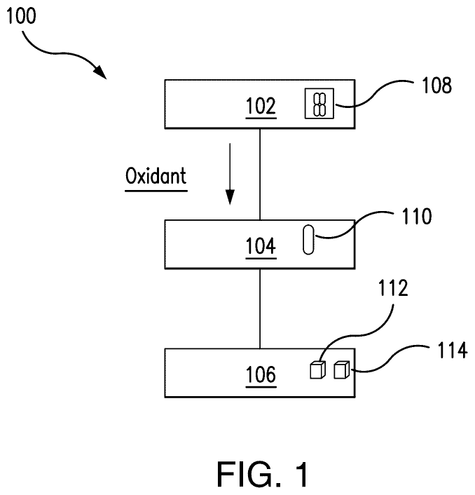

In certain embodiments of the disclosed matter, an exemplary system 100 for quantifying breakdown products in an acid copper plating bath is shown as illustrated in FIG. 1. The system 10 includes a spiking apparatus 102, an HPLC system 104, and a processing unit 106. A suitable HPLC system 104 can include an HPLC-UV detector. The processing unit 106 can include a processor. The processor can be configured to perform the instructions specified by software stored in a hard drive, a removable storage medium, or any other storage media. The software can be written in a variety of languages, e.g., MATLAB and/or Microsoft Visual C++. Additionally or alternatively, the processor can include hardware logic, such as logic implemented in an application-specific integrated circuit (ASIC). The processor can be configured to control one or more of the system components.

In the implementation for quantitation, the spiking apparatus 102 adds a predetermined amount of oxidant to the sample in a copper plating bath. Samples are pre-prepared by injecting an amount of the analyte of interest into the HPLC system 104 in a concentrated form. This can be done using a syringe or other manual injection method, or automation thereof. One goal is to target a specific analyte in the sample. By focusing on a specific analyte, the HPLC system 104 can separate the components more efficiently and with greater accuracy. The processing unit 106 is connected with the HPLC system 104 in the downstream, for calibrating the HPLC response of analyte and breakdown thereof and calculating the quantitation of breakdown products thereof. The processing unit 106 includes computing unit 112 and storage unit 114.

### Example 1: The Effect of Spiked H₂O₂ on SPS and its Breakdown Products

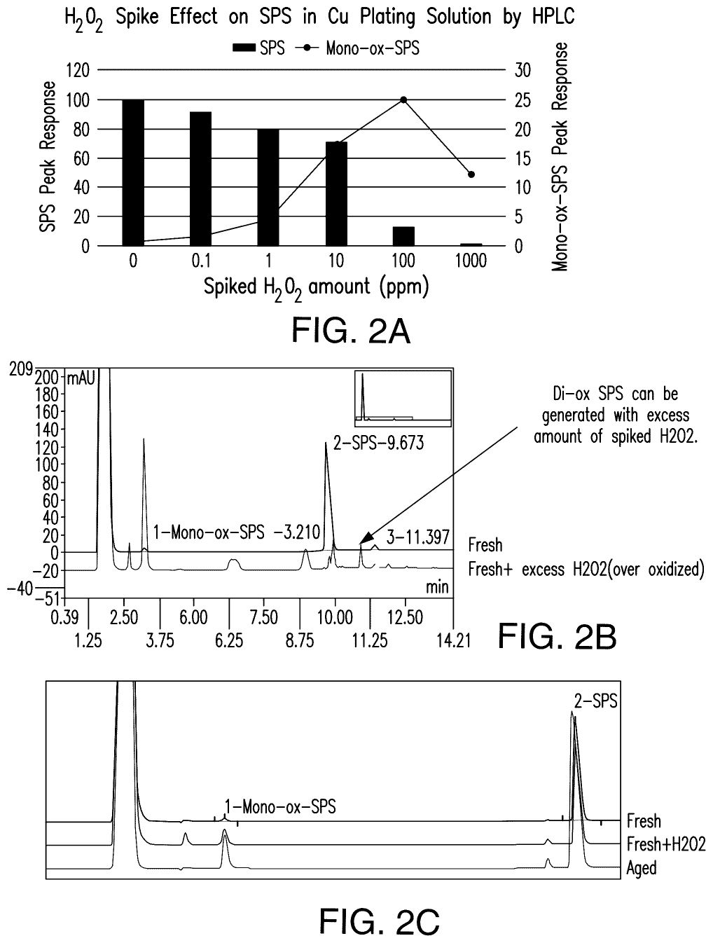

Measurements were implemented to determine if other breakdown products than Mono-ox-SPS with different amounts of spiked H₂O₂ were produced during the reaction of SPS at a concentration of 100 ppm in the quantitation. FIG. 2a illustrates the effect of spiked H₂O₂ on SPS response and Mono-ox-SPS response in HPLC. An increasing trend of Mono-ox-SPS with higher spiked H₂O₂ (less than 100 ppm) is observed, further increasing spiked H₂O₂ amount (more than 100 ppm) will lead to decreasing quantity of Mono-ox-SPS, which is an indication of over-oxidation. In this particular case, the linear correlation between increasing Mono-ox-SPS and decreasing SPS exists between 0 to 10 ppm spiked H₂O₂.

Rather than Mono-ox-SPS, other breakdown products of SPS, including Di-ox-SPS, can be produced with an excess amount of spiked H₂O₂, as illustrated in FIG. 2b. FIG. 2b shows that at retention time of around 11.00 min, a Di-ox-SPS featured peak appeared in the HPLC chromatograph.

To remove the error data points from Di-ox-SPS, the amount of oxidant was measured and controlled in the present embodiment. A molar ratio of H₂O₂:SPS ranging from 0.1 to 2 was found to be appropriate to control the effective breakdown of SPS to Mono-ox-SPS.

As shown in FIG. 2c, at a molar ratio, e.g., 1:1, featured HPLC peak of Di-ox-SPS is not present. Notably, for Mono-ox-SPS, the peak response increases which indicates the generation of Mono-ox-SPS after spiking oxidant. Furthermore, the shape of HPLC peak is substantially symmetrical with narrow peak width, indicating a good separation efficiency and high resolution of the HPLC method when applied into Mono-ox-SPS quantitation.

### Example 2: Analysis and Calculation of data for Quantitation

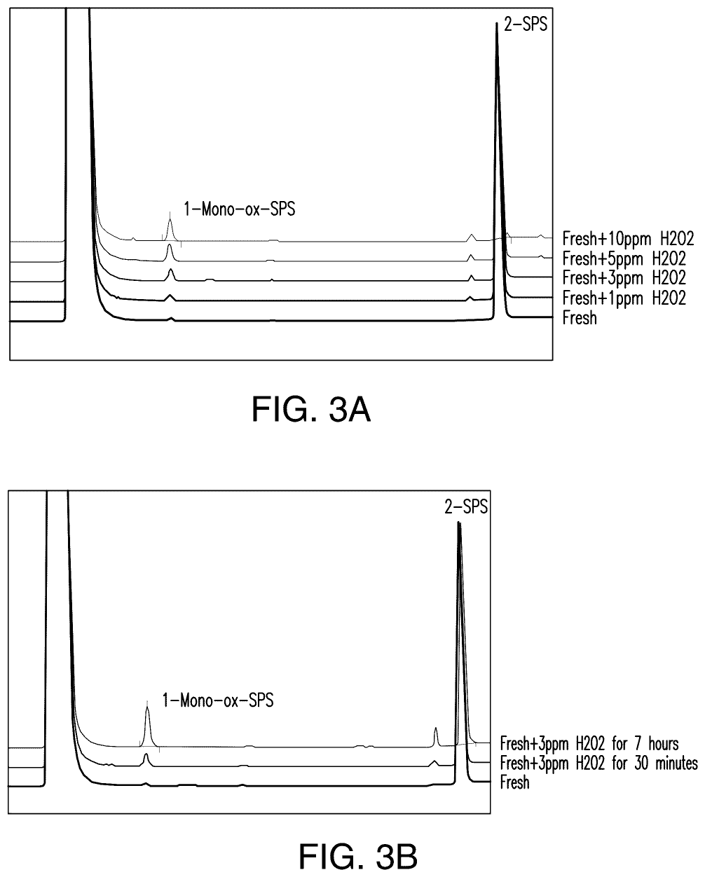

In the present example, quantitation with different levels of spiked H₂O₂ for a representative commercial Cu plating bath sample was implemented. At the time of HPLC analysis, each sample was kept for around 30 minutes and 7 hours after being spiked by H₂O₂. As illustrated in FIG. 3a and FIG. 3b, with higher spiked H₂O₂ amount or longer oxidation time, the Mono-ox-SPS peak is showing an increasing trend while the SPS peak is showing a decreasing trend.

Associating with different HPLC responses for SPS and the known amount of SPS in fresh bath sample, SPS amounts in each spiked sample were calculated, then the decreasing amount of SPS was calculated. Based on the assumption that 1 mole of SPS is oxidized into 1 mole of Mono-ox-SPS under certain conditions, the increasing amount of Mono-ox-SPS in each spiked sample was calculated.

TABLE 1

| Mono-ox- | SPS | SPS |
|---|---|---|
| SPS Peak | Peak | amount |
| Response | Response | (ppm) |
| 0.73 | 93.95 | 100 |
| 2.15 | 91.55 | 97.45 |
| 4.20 | 87.48 | 93.12 |
| 5.63 | 86.03 | 91.57 |
| 7.48 | 83.27 | 88.63 |
| 5.51 | 83.10 | 88.45 |
| 12.75 | 71.55 | 76.16 |
| 18.13 | 59.79 | 63.64 |
| 25.42 | 43.40 | 46.19 |

Table 2 lists decreased amount of SPS and increased amount of Mono-ox-SPS, which were calculated based on the data in Table 1 at 210 nm peak.

TABLE 2

| Mono-ox-SPS | SPS | Mono-ox- |
|---|---|---|
| Peak Response | (ppm) | SPS (ppm) |
| Increase | decrease | increase |
| 0 | 0 | 0 |
| 1.4252 | 2.55 | 2.69 |
| 3.4672 | 6.88 | 7.24 |
| 4.9039 | 8.43 | 8.87 |
| 6.7533 | 11.37 | 11.96 |
| 4.7828 | 11.55 | 12.15 |
| 12.0198 | 23.84 | 25.07 |
| 17.3988 | 36.36 | 38.24 |
| 24.6876 | 53.81 | 56.59 |

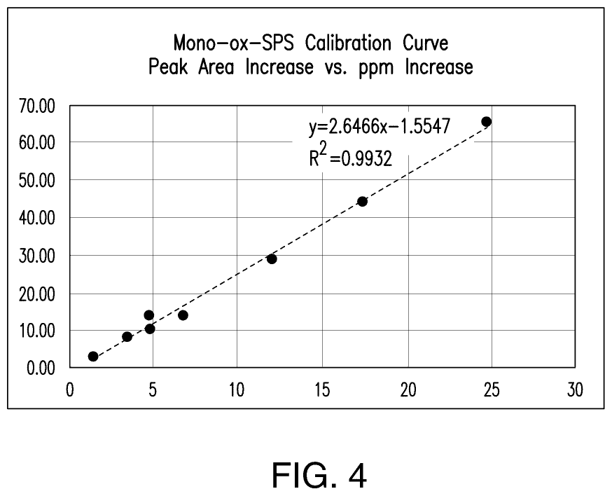

By correlating the HPLC peak response increase and the calculated increasing amount of Mono-ox-SPS (listed in the last two column in table 2), a linear calibration curve for Mono-ox-SPS quantitation can be generated, as shown in FIG. 4.

The accuracy of quantitation of the present embodiment is high since the linearity plot is substantially linear. Notably, the calibration plot for the implemented quantitation method was created as linearity functions:

$$y = x * 2.6466 - 1.5 \; 547 \qquad {R}^{2} = 0.9932$$

wherein, R² refers to the coefficient of determination, indicating the proportion of the variation in the output response that can be explained by the variation in the input signal. In the linearity calibration of the present example, R² value is about 1.0, demonstrating a substantial fit to the linear model.

In addition to the various embodiments depicted and claimed, the disclosed subject matter is also directed to other embodiments having other combinations of the features disclosed and claimed herein. As such, the particular features presented herein can be combined with each other in other manners within the scope of the disclosed subject matter such that the disclosed subject matter includes any suitable combination of the features disclosed herein. The foregoing description of specific embodiments of the disclosed subject matter has been presented for purposes of illustration and description. It is not intended to be exhaustive or to limit the disclosed subject matter to those embodiments disclosed.

It will be apparent to those skilled in the art that various modifications and variations can be made in the systems and methods of the disclosed subject matter without departing from the spirit or scope of the disclosed subject matter. Thus, it is intended that the disclosed subject matter include modifications and variations that are within the scope of the appended claims and their equivalents.

What we claim is:

1. A quantitation of an unstable or breakdown product without the usage of standard chemical, comprising:
a) generating an unstable or breakdown product from a raw material to an in situ chemical reaction;
b) calculating a concentration increase of the unstable or breakdown product based on the stoichiometric relation between the quantity of the unstable or breakdown product and the decrease of raw material;
c) correlating an increased detector signal to the concentration increase of the unstable or breakdown products; and
d) establishing a calibration curve based on the correlation.

2. The quantitation of claim 1, wherein the in situ chemical reaction is selected from a reduction, oxidation, or a combination thereof.

3. The quantitation of claim 1, wherein the increased detector signal is detected by a High-Performance Liquid Chromatography (HPLC) detector.

4. A method for quantifying a breakdown product of bis (3-sulfopropyl)-disulfide (SPS), in an acid copper plating bath, comprising:
a) spiking a predetermined amount of oxidant into a copper bath solution containing the SPS as an accelerator;
b) generating a breakdown product by oxidizing the SPS;
c) analyzing High-Performance Liquid Chromatography (HPLC) values in the acid copper plating bath; and
d) calculating a quantitation of the breakdown product based on the HPLC values.

5. The method of claim 4, wherein the oxidant is selected from the group consisting of H₂O₂, S₂O₈²⁻, O₃, MnO₄⁻, Cr₂O₇²⁻, Fe (III), Ce (IV).

6. The method of claim 4, wherein the concentration of oxidant is from 0.1 to 100 ppm.

7. The method of claim 4, wherein the concentration of SPS in the copper plating solution is from 1 to 1000 ppm.

8. The method of claim 4, wherein the molar ratio between the oxidant and SPS is from 0.001 to 1000.

9. The method of claim 4, wherein the concentration of Mono-ox-SPS is from 0.1 to 100 ppm.

10. The method of claim 4, wherein the oxidant is Hydrogen Peroxide (H₂O₂).

11. The method of claim 10, wherein the molar ratio of H₂O₂:SPS is from 0.1 to 2.

12. The method of claim 4, wherein the analyzing HPLC values comprises analyzing a HPLC peak response.

13. The method of claim 4, further comprises calculating an amount of increasing Mono-ox-SPS and decreasing SPS.

14. The method of claim 4, further comprises a calibration of a linearity curve based on the calculation.

15. A system for quantifying breakdown products in an acid copper plating bath, comprising:
a) a spiking apparatus for adding a predetermined amount of oxidant to a copper plating bath including an analyte;
b) an HPLC system for analyzing the amounts of analyte and breakdown products thereof in the bath; and
c) a processing unit for calibrating the HPLC response of analyte and breakdown thereof and calculating the quantitation of breakdown products thereof.

16. The system of claim 15, wherein the breakdown products include Mono-ox-SPS.

17. The system of claim 15, wherein the HPLC system includes an HPLC-UV detector.
